(19) United States
(12) Patent Application Publication
(10) Pub. No.: US 2009/0114681 A1
(43) Pub. Date: May 7, 2009

(54) Clog-proof nozzle

(76) Inventor: Scott R. Mabry, San Antonio, TX (US)

Correspondence Address: Stephen R. Greiner, Esquire;GREINR LAW OFFICES, P.C., Suite 110, 6701 Democracy Blvd., Bethesda, MD, 20817, US

(21) Appl. No.: 11/979,660

(22) Filed: Nov. 7, 2007

(51) Int. Cl. B67D 1/08; B67D 3/00

(52) U.S. Cl. 222/148; 222/543

(57) ABSTRACT

A nozzle that inhibits clogging while dispensing granular material. The nozzle includes a tubular spout having an interior passageway through which a granular material flows. A cap is releasably fitted upon the spout for selectively stopping the flow of granular material from the passageway. A stiff cord connects the cap to the spout. The cord has opposed ends, with one of the ends being positioned within the passageway and being provided with a bulge thereon. When the cap is released from the spout and caused to swing upon the cord, the cord wiggles the bulge to maintain the flow of the granular material in the passageway.

### FIELD OF THE INVENTION

The present invention relates generally to dispensing devices with single strand cord or wire connectors for removable outlet elements.

### BACKGROUND OF THE INVENTION

In order to successfully hunt for deer, a hunter must position himself in an area where deer congregate. These areas typically surround sources of food and water. They also include enough trees or brush to provide adequate cover from predators. With a minimal effort, a hunter can provide an environment that attracts deer and keeps them there.

One of the easiest ways to attract deer is to spread corn kernels, a favored food of deer, on the ground. Many hunters simply throw kernels from buckets carried into the field. This can be tiring and rough on the hands, however, especially if a large area is being covered with feed. To overcome the problem of having to cast the feed by hand, bags having spouts for pouring kernels onto the ground have been proposed. Unfortunately, the kernels tend to form clumps in the nozzles, necessitating that the nozzles be unclogged from time to time by inserting a finger or other pointed object into them. Unclogging is inconvenient and a waste of time.

### SUMMARY OF THE INVENTION

In light of the problems associated with the known methods and apparatus for dispersing granular feed for attracting game animals, it is a principal object of the invention to provide a clog-proof nozzle, adapted for use with a feed-carrying bag, that inhibits clogging while dispensing granular material like corn kernels.

It is another object of the invention to provide a nozzle of the type described that can be used with minimal training and without resort to tools of any sort.

It is an object of the invention to provide improved features and arrangements thereof in a nozzle for the purposes described that is lightweight in construction, inexpensive to manufacture, and dependable in use.

Briefly, the nozzle in accordance with this invention achieves the intended objects by featuring a tubular spout having an interior passageway for the movement of a granular material. The spout also has external, helical threads and a hole above the external threads for access to the passageway. A cap is releasably fitted upon the spout for selectively stopping the flow of granular material from the passageway. The cap has internal, helical threads adapted for screwing onto the external threads of the spout. A stiff cord connects the cap to the spout. The cord has opposed ends with one of the ends extending loosely through the hole and into the passageway. A fitting or crimp is secured to the cord end extending into the passageway. When the cap is released from the spout and caused to swing upon the cord, the cord wiggles the fitting to maintain the flow of the granular material in the passageway.

The foregoing and other objects, features, and advantages of my nozzle will become readily apparent upon further review of the following detailed description and accompanying drawings.

### BRIEF DESCRIPTION OF THE DRAWINGS

My clog-proof nozzle can be more readily described with reference to the accompanying drawings, in which:

FIG. 1 is a side elevational view of a clog-proof nozzle in accordance with the present invention with the cap thereof screwed onto the spout thereof.

FIG. 2 is a side elevational view of the nozzle of FIG. 1 with portions broken away and with the cap unscrewed from the spout.

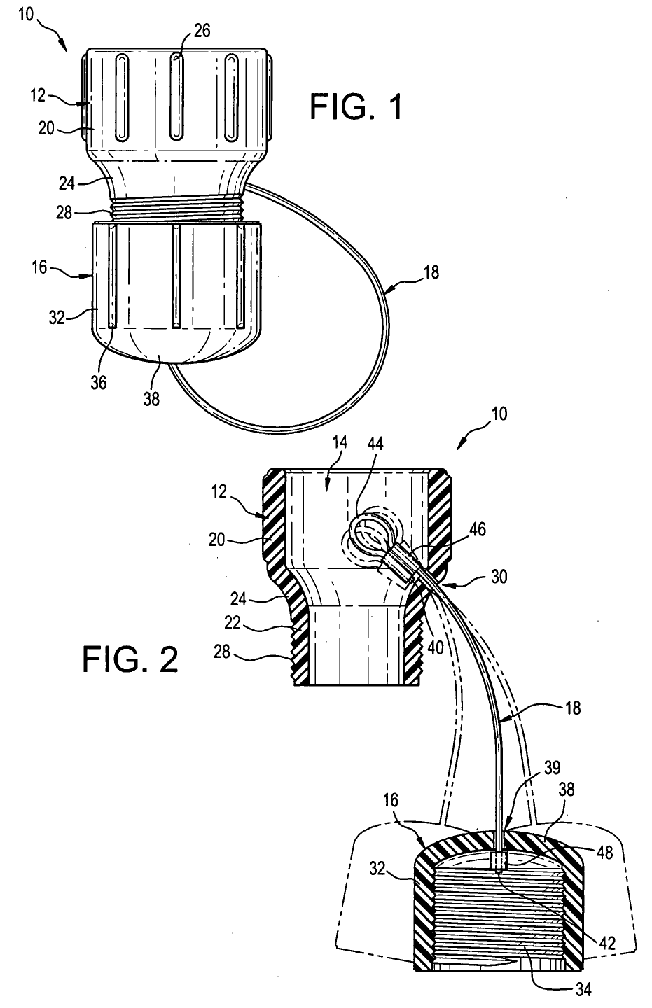

Similar reference characters denote corresponding features consistently throughout the accompanying drawings.

### DETAILED DESCRIPTION OF THE CLOG-PROOF NOZZLE

Referring now to the figures, a clog-proof nozzle in accordance with the present invention is shown at 10. Nozzle 10 includes a tubular spout 12 having an interior passageway 14 through which a granular material (not shown) may be caused to flow under the influence of gravity. A cap 16 is releasably fitted over the bottom of spout 12 to selectively stop the flow of granular material. Cap 16 is connected to spout 12 by means of a stiff cord 18.

Spout 12 includes a tubular mounting section 20 of large diameter that is connected to a tubular dispensing section 22 of small diameter by a transition section 24 that tapers in diameter. Sections 20, 22, and 24 define a smooth-sided, funnel-like, interior passageway 14 that extends from the top to the bottom of spout 12. Preferably, sections 20, 22, and 24 are integrally molded from a durable plastic, but can be made by any desired process and from any suitable material.

Spout 12 has several, external features of note. Mounting section 20, for example, has a number of ridges 26 that are evenly spaced around its periphery for reinforcement purposes and to enhance a grip upon spout 12 when wet. Also, dispensing section 22 has external, helical threads 30 about its periphery. A hole 30 penetrates transition section 24 at a single point.

Cap 16 includes a cylindrical, side wall 32 that is configured for positioning over dispensing section 22 of spout 12. The interior of side wall 32 is provided with interior, helical threads 34 that can be screwed into snug engagement with threads 28 on dispensing section 22 so as to retain cap 16 upon spout 12. The exterior of side wall 32 is provided with a number of ridges 36 that are evenly spaced around its periphery for reinforcement purposes and to enhance the grip of a user upon cap 16. A circular, bottom wall 38 is connected to the bottom of side wall 32 and prevents the flow of granular material through cap 16. Bottom wall 38 has a hole 39 at its center for the passage of cord 18.

Cord 18 has opposed ends 40 and 42. End 40 extends loosely through hole 30 in spout 12 and is folded back upon itself so as to form a small loop or bulge 44 in passageway 14. The loop 44 is maintained by an anti-clog fitting or crimp 46 affixed in the usual manner to cord 18. End 42, on the other hand, extends linearly through hole 39 in cap 16. A crimp 48 affixed to end 42, and having a size larger than hole 39, ensures that cap 16 and cord 18 remain firmly attached to one another.

Cord 18 is a piece of string, twine, rope, cable, wire, or thread having a length sufficient to permit cap 16 to swing from side to side when suspended below spout 12. Preferably, cord 18 is a stiff, plastic monofilament but can be constructed from other suitable materials like wound or braided, natural and artificial fibers or filaments. Regardless of the construction of cord 18, cord 18 must have sufficient rigidity or stiffness so that, as cap 16 swings from side to side in the flow of granular material flowing from spout 12, it can act as a lever arm to convey the swinging movement to the clog-inhibiting bulge located within passageway 14, i.e., loop 44.

The use of nozzle 10 is straightforward. First, spout 12 is attached in a suitable manner to the bottom of a container (not shown) that is subsequently filled with a granular material such as corn kernels. Next, the filled container is taken to an area where a user desires to disperse the granular material which, in the case of a deer hunter wishing to spread corn kernels, may be the edge of a wooded lot. Now, cap 16 is unscrewed from dispensing section 22 to permit the corn kernels to flow from the container and through passageway 14. As the user walks around, and as the corn kernels strike bottom wall 38 and side wall 32, cap 16 is caused to swing around like a pendulum. The swinging motion disperses the corn kernels and, further, causes loop 44 and crimp 46 to wiggle. The wiggling loop 44 and crimp 46 prevent clogs from forming in passageway 14 thereby permitting the corn kernels to be quickly and evenly distributed.

While nozzle 10 has been described with a high degree of particularity, it will be appreciated by those skilled in the art that modifications can be made to it. For example, it is possible that my nozzle can be molded, or otherwise made, as an integral part of the container for the granular material from which dispensing will occur. Also, the clog-inhibiting bulge need not be formed, in part, by loop 44 or crimp 46, but could be made by forming a simple knot at end 40 of cord 18. Therefore, it is to be understood that the present invention is not limited to nozzle 10, but encompasses any and all nozzles within the scope of the following claims.

I claim:

1. A nozzle, comprising:
a tubular spout having an interior passageway for the movement of a granular material;
a cap being releasably fitted upon said spout for selectively stopping the flow of granular material from said passageway; and,
a stiff cord connecting said cap to said spout, and said cord having opposed ends with one of said ends being positioned within said passageway and being provided with a bulge thereon;
whereby, when said cap is released from said spout and caused to swing upon said cord, said cord wiggles said bulge to prevent the clogging of the granular material in said passageway.

2. A nozzle, comprising:
a tubular spout having an interior passageway for the movement of a granular material, said spout also having external, helical threads and a hole above said external, helical threads for access to said passageway;
a cap being releasably fitted upon said spout for selectively stopping the flow of granular material from said passageway, said cap having internal, helical threads adapted to be screwed onto said external helical threads of said spout;
a stiff cord connecting said cap to said spout, and said cord having opposed ends with one of said ends extending loosely through said hole and into said passageway; and,
a fitting being secured to said one of said cord ends extending into said passageway;
whereby, when said cap is released from said spout and caused to swing upon said cord, said cord wiggles said fitting to prevent the clogging of the granular material in said passageway.
